(19) United States
(12) Patent Application Publication
(10) Pub. No.: US 2009/0083338 A1
(43) Pub. Date: Mar. 26, 2009

(54) SYNCHRONIZATION OF ELECTRONIC POSTINGS

(75) Inventors: Christopher A. Evans, Seattle, WA (US); Raymond E. Ozzie, Seattle, WA (US); George P. Moromisato, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/859,739

(22) Filed: Sep. 21, 2007

(51) Int. Cl. G06F 17/30

(52) U.S. Cl. 707/201; 707/E17.007

(57) ABSTRACT

Systems and methods of providing synchronization of electronic postings are disclosed herein. A first pre-existing file item is identified in a first file system of a first computing device. A first posting can be received at the first file system. The first posting can a user-entered posting. The first posting can be associated with the first pre-existing file item in the first file system. A synchronization request can be sent to a second file system of a second computing device. The synchronization request causes the second file system to automatically create a second posting and to associate the second posting with a second pre-existing file item in the second file system. The second posting in the second file system is a synchronized copy of the first posting.

### BACKGROUND

A wide variety of synchronization systems exist that synchronize data between different endpoints, such as between different computing devices. Frequently, file organization in a shared space requires discussion among users regarding files and folders in that shared space. Users may have discussions about the intent, content or context of the files or folders. In conventional systems, users exchange messages via media such as email messaging. In other systems, users annotate messages in the documents or other files being discussed thereby altering the content of the files or documents being discussed.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Described herein are various techniques and technologies directed to permitting a synchronized discussion of synchronized files and folders among synchronized computing devices without necessarily modifying the files or folders being discussed. Thus, users are enabled to add postings and conduct threaded discussions directly in the context of the files and folders that contain the actual content that is being discussed, including the ability to link messages to individual or groups of files and to have that discussion roam with those files between users' computing devices while maintaining the connection to the original files and organization context.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates a component diagram of a system for providing electronic posting synchronization according to one embodiment.

FIG. 2 illustrates a component diagram of a computing device configured for electronic posting synchronization according to one embodiment.

FIG. 3 illustrates a component diagram of an originating computing device and a target computing device according to one embodiment.

FIG. 4 illustrates an exemplary user interface diagram for viewing and managing file system items and related postings according to one embodiment.

FIG. 5A illustrates an exemplary user interface diagram for viewing and managing file system items and related postings according to another embodiment.

FIG. 5B illustrates an exemplary user interface diagram for viewing and managing file system items and related postings according to yet another embodiment.

FIG. 6 illustrates an exemplary user interface diagram for viewing and managing postings according to one embodiment.

FIG. 7 illustrates an exemplary user interface diagram for entering a posting according to one embodiment.

FIG. 8 illustrates a flow diagram of a process for sending a synchronization request to synchronize a posting according to one embodiment.

FIG. 9 illustrates a flow diagram of a process for receiving a synchronization request to synchronize a posting according to one embodiment.

FIG. 10 illustrates a component diagram of a computing device for implementing one or more embodiments.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The system described is provided as an example and not a limitation. As those skilled in the art will appreciate, the present examples are suitable for application in a variety of different types of synchronization of postings.

Described herein are various techniques and technologies directed toward an implementation of posting synchronization where postings are modified on a synchronization computing device without necessarily modifying files and folders being discussed. As such, the systems and methods disclosed herein permit to synchronize postings within synchronized folders of file systems in different computing devices. Exemplary file systems are Windows Explorer®, MacOS Finder®, and the like. Postings can be messages posted in association with a file system item. For example, a user can add a posting to a document in his computing device. If that document has a synchronized copy in a computing device of a second user, the system disclosed herein can permit the posting to also be synchronized in the computing device of the second user. The posting in the second computing device can be associated with the synchronized copy of the document in the second computer.

Postings as disclosed herein can be a discrete text item associated with a file system item. In one example, postings can be similar to an entry on an electronic message board.

As used herein, file system items are items such as folders, and files of any type and any other discrete unit of data that can be synchronized among file systems of two or more computing devices. Exemplary files include text files, image files, media files, and the like.

Furthermore, a synchronized copy, as used herein, refers to a copy of a file system item in another computing device. Thus, a file system item can reside in two computing devices, wherein an instance of the file system item resides on each computing device. Each instance of the file system item is a synchronized copy of the other. Thus, any change that is made to one instance of the file system item in one of the computing devices is reflected and propagated to all other instances of the file system item.

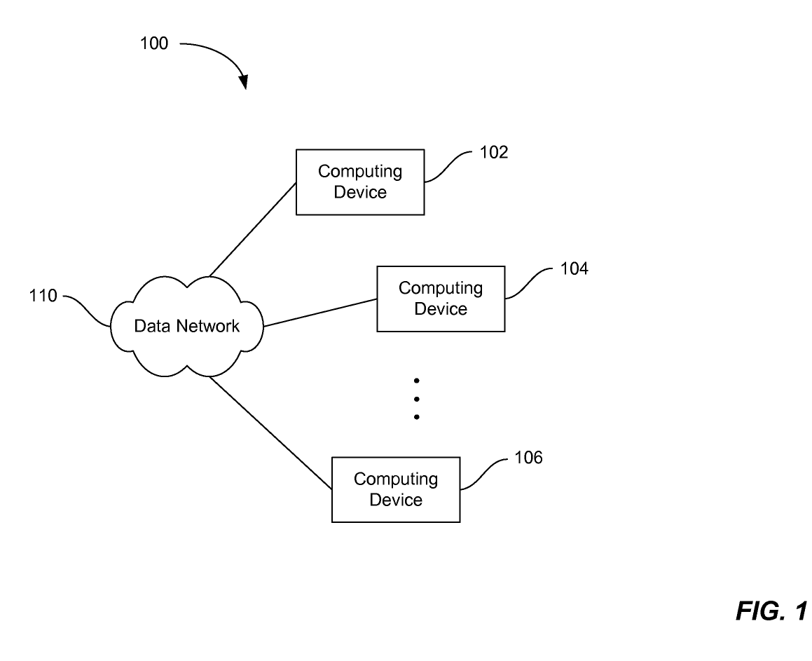

FIG. 1 illustrates a component diagram of a system for providing electronic posting synchronization according to one embodiment. The synchronization system 100 permits a user to create posting a computing device such as computing device 102 in association with a file or folder. Upon user entering the posting, the posting can be automatically synchronized in other computing devices in association with corresponding synchronized files or folder in the other computers.

The synchronization system 100 may be comprised of executable computer code that communicates postings between multiple computing devices of a wide variety of types. In one embodiment, the synchronization system 100 might synchronize file system items between different computers. File system items can include computer-implemented directories and files. Using such a system, a user might be able to keep a directory, and all files (and perhaps subdirectories) in the directory, synchronized between multiple computers. When a user changes a file in the synchronized directory, the modification or the changed file might be synchronized or transferred through a variety of means from the computing device on which the change was made to one or more other computing devices. When a user adds a new file, the new file might be similarly communicated, and so on. The same or one or more other synchronization systems might also synchronize any of a wide variety of other types of postings.

In one embodiment, postings associated with file system items can also be synchronized. In one example, a posting associated with a file can be synchronized between multiple computing devices. In another example, a posting associated with a folder can be synchronized between multiple computing devices.

In the exemplary system 100 postings may be synchronized and shared. The exemplary system 100 contains computing device 102, computing device 104, and computing device 106, as well as the exemplary data network 110. In one example, computing device 102, computing device 104, and computing device 106 are peer computers that transmit and receive data via the data network 110. Generally, a sharing or synchronization relationship may exist between two or more computing devices. A particular sharing relationship may generally relate to a set of postings comprising one or more postings items, or simply postings. When a new posting is entered at one computing device, the new posting might be synchronized to the other computing devices in the synchronization relationship.

In one example, where two computing devices, such as computing device 102 and computing device 102 are in a sharing relationship, both computing devices publish and subscribe. As such, each computing device may create “local” postings associated with file system items, where a “local” posting made is made on one computing device. Then, so the postings being shared are kept the same on both computing devices, the local posting may be published to another computing device via a synchronization requests.

In one example, computing device 102 (or computing device 104 or some other computing device including those not shown) might participate in a sharing or synchronization relationship with, say, computing device 106. Computing device 102 may store a pre-existing document, or other file system item. Computing device 104 may store a pre-existing document, or other file system item, which is a synchronized copy of the document of computing device 102. A posting can be received by the file system of computing device 102. The posting can be received from a user, or an automated process, that associates the posting with the pre-existing document in the computing device 102.

The computing device 102 can then send a synchronization request to the computing device 104. The computing device 104 can then automatically create a local posting and associate the newly created posting the pre-existing document in the computing device 104. As such, a user at the computing device 102 can add a posting associated to a document, file, folder, or any other file system item, and such posting can then be propagated to computing device 104 and computing device 106. In this manner, not only file system items can remain synchronized, but also any postings associated with one or more file system items.

Computing device 102 and computing device 106 are shown in the system 100 as being connected by an exemplary data network 110. Such an exemplary communications means should be interpreted as including any means by which postings may be transmitted, including any type of network or any other kind of transfer, including the transfer of physical media, like a compact disc (CD) or flash memory drive. Computing devices might also be connected directly, such as might be illustrated, for example, by the connection between computing device 102 and computing device 104.

The information that is shared and synchronized between computing devices may be stored in a variety of manners and locations. In at least one implementation, a computing device might store synchronized postings locally on the same computing device or remotely on one or more other computing devices. Such storage may in some cases be embodied by one or more disk drives or magnetic or other storage devices, or by any other mechanism by which postings may be stored. When some or all of the synchronized postings is accessed remotely, the postings may be accessed, for example, using a network or other communication means.

While synchronization of postings may be implemented in a wide variety of fashions and using a variety of techniques and technologies, in at least some implementations, synchronization of postings may be implemented, at least in part, by the addition of particular postings to a feed of postings provided using a possibly widely accepted protocol like RSS (“Really Simple Syndication” or “Rich Site Summary”) or ATOM. For example, in an exemplary implementation with a topology that consists of only two computing devices that communicate with each other, a publisher—such as perhaps computing device 102, in at least one example—might publish an RSS or Atom feed that contains some type or types of information. In perhaps one example, the feed might include postings representing directories and files. In yet another example, the feed might represent, contain, or reference any other postings.

A subscriber, such as perhaps computing device 106 in one example, might subscribe to the feed provided by the first computing device and be notified when, for example, the first computing device adds a new file, modifies an existing file, and so on. In addition, a subscribing computing device might publish its own feed, with the same postings as is provided in the original publisher's feed and also with changes or additions made by the subscriber. The original publisher might then subscribe to this second feed. Through these mutual subscriptions, changes made by either computing device may be reflected in the postings maintained by both computing devices. Furthermore, multiple computing devices may participate and share the same postings by subscribing to at least one of the feeds provided by another computing device and similarly publishing their own feed.

In at least some implementations, the synchronization information in a feed, and the processes to be followed by at least particular computing devices when exchanging postings, may be the same as or similar to those associated with a protocol such as “Simple Sharing Extensions” (SSE). SSE may be understood generally as defining extensions to—or additional postings to be used with—feed protocols like RSS and Atom, or other feed protocols or documents, where the extensions relate to information that may be used when transferring or synchronizing postings using a feed. In some cases, an RSS, Atom, or other type of feed that includes SSE information may be referred to as an “SSE feed.”

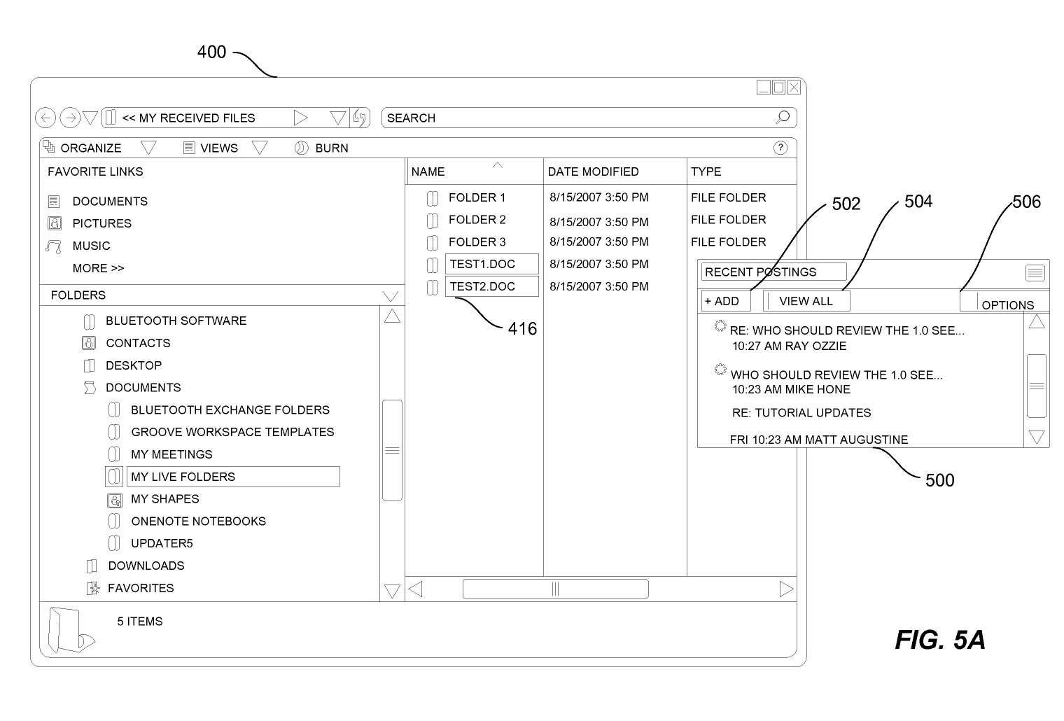

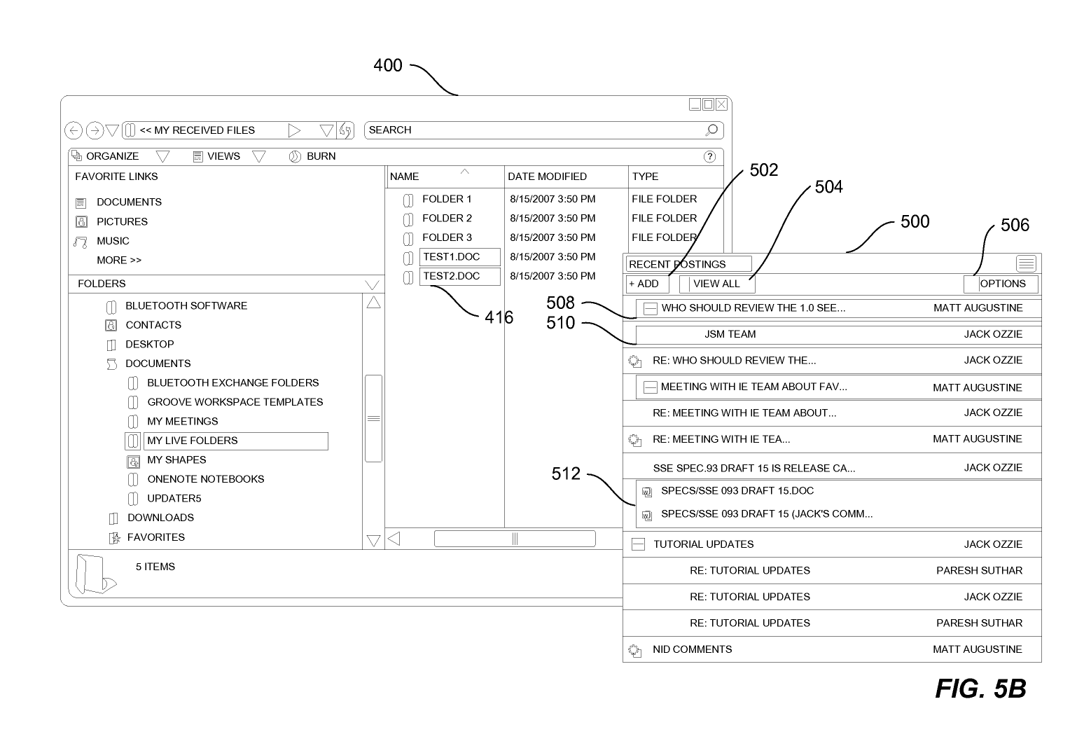

Each computing device shown in this system might represent any number of general-purpose or dedicated computers, including desktop computers, server computers, laptop computers, workstation computers, mobile or cellular telephones, connected personal digital assistants (PDAs), and the like. In at least some implementations, a computing device may be implemented by a computing environment including the exemplary computing environment discussed below with reference to FIG. 5.

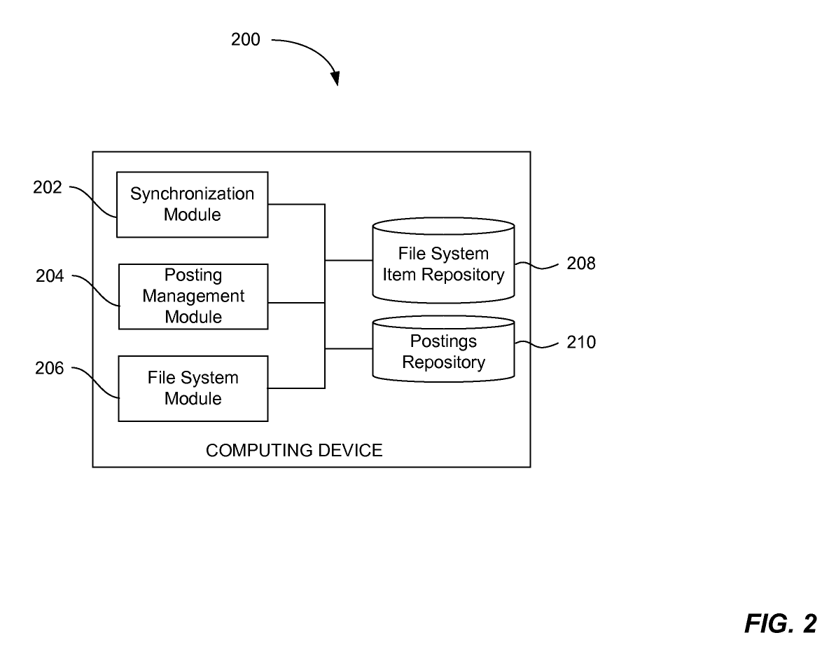

FIG. 2 illustrates a component diagram of a computing device configured for electronic posting synchronization according to one embodiment. The component diagram illustrates modules that can be configured with computer software that permits the computing device 200 to either submit a synchronization request or receive a synchronization request.

The computing device 200 can include a synchronization module 202, the posting management module 204, and a file system module 206. The file system module 206 can be configured to manage files, folders, or any other type. In addition, the file system module 206 can be configured to synchronize files and folders with file systems in other computing devices. As such, the file system module 206 can also be configured to retrieve and store files and folders in the file system items repository 208. The file system module 206 can further be configured to communicate data with the synchronization module 202 in order to submit synchronization requests to, and receive synchronization requests from other computing devices.

The posting management module 204 can be configured with logic to manage a postings associated with one or more file system items, such as files or folders. In one embodiment, the posting management module 204 associates a posting with a file or folder by including an item identifier in metadata of a posting. For instance, a posting can include metadata indicative of the document identifier of one or more document associated with such posting. The posting can be propagated to various computing devices 102, 104, and 106, such that all computing devices include the same synchronized content of the posting, and also the document.

In another embodiment, the posting management module 204 associates a file system item with one or more postings by adding a posting identifier to metadata of a file system item. The posting identifier can be added to the metadata of the file system item without altering the file system item. For instance, a document can be associated with metadata indicative of the posting identifier of one or more postings that are in turn associated with such document. The document can be propagated to various computing devices 102, 104, and 106, such that all computing devices include the same synchronized content of the document as well as the associated metadata containing the posting identifier. Therefore, the file item itself is not altered, but only the metadata associated with the file item.

In one embodiment, a file system item, such as a document, can be associated with a posting in response to a user input requesting to make such association. In another embodiment, a file system item can be associated with a posting in as a result of the first pre-existing document being viewed by a user. Thus, a new posting by a user can be automatically associated with the document, file, folder, or any other file system item that is being currently accessed by a user.

In another embodiment, a file system item can be associated with a posting in as a result of the first pre-existing document being last edited. In other words, a new posting by a user can be automatically associated with the file or folder that was most recently accessed, or edited by the user.

The synchronization module 202 can be configured to manage the synchronization of the files and folders in the computing device 200 with the files and folders of other computing devices. Likewise, the synchronization module 202 can be configured to manage the synchronization of postings in the computing device 200 with the files and folders of other computing devices.

In one embodiment, a synchronization module 202, a posting management module 204, and a file system module 206 can be configured in one or more computing devices that synchronize among each other files and folders and corresponding postings. For example, one computing device can be an originating computing device, and another computing device target computing device.

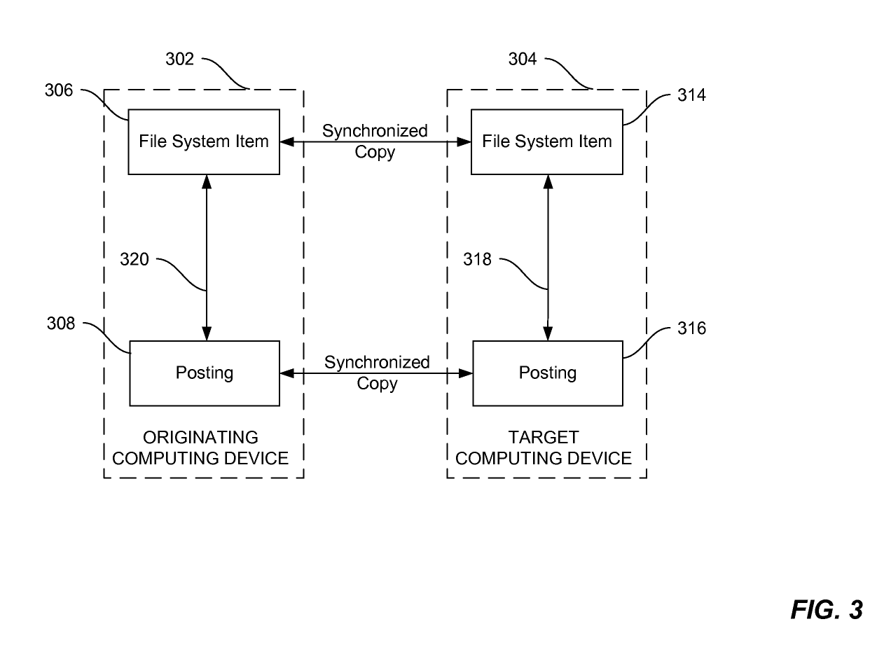

FIG. 3 illustrates a component diagram of an originating computing device and a target computing device according to one embodiment. The originating computing device 302 may receive a posting 308 that can be synchronized with the target computing device 304. The posting 308 can be received from a user at the originating computing device 302. The posting 308 can be associated to a file system item 306. As previously mentioned, the file system item 306 can be a folder or any type of file, such as a text file, image file, media file, and the like. Similarly, the target computing device 304 can include a file system item 314 which is a synchronized copy of the file system item 306. Again, the file system item 314 can be any type of folder of file.

Upon receiving the posting 308, the synchronization module in the originating computing device 302 can be configured to send a synchronization request to the target computing device 304. The synchronization module of the originating computing device 302 can be configured to indicate the file or folder with which the request is associated. For instance, the request can be a message that includes the posting and an identifier of a file system item. Therefore, the file system item 306 and the file system item 314 can have a common identifier such that when a synchronization request is received from the originating computing device 302, the target computing device can identify the file system item 314.

The target computing device 304 can also be configured with a synchronization module. Thus, upon receiving a synchronization request, the synchronization module in the target computing device 304 can be configured to locate the file system item 314. The synchronization module of the target computing device 304 can then create a posting 316 which is a synchronized copy of posting 308. The contents of posting 316 and 308 are configured to be the same.

The posting 316 can be associated with the file system item 314 via an association 318. The association 318 can be established based on date received at the synchronization request indicative of the file system item with which the posting being synchronized is to be associated. In one embodiment, the file system item 314 is a pre-existing item, such as a pre-existing document, stored in the target computing device and synchronized with file system item 306.

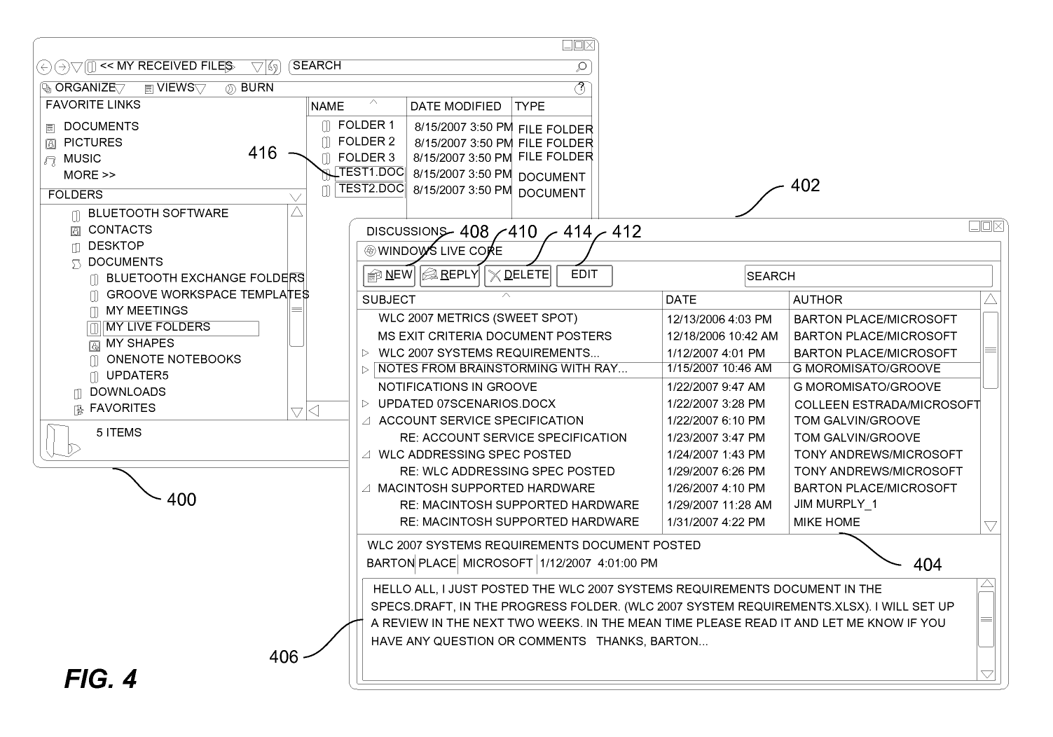

Various user interfaces can be implemented to provide a user to use a file system as disclosed here. FIGS. 4-9 illustrate various user interfaces for interacting with the file system synchronization as discussed above. In one example, the user interface diagrams in FIGS. 4-9 depict a user interface at an originating computing device. In another example, the user interface diagrams in FIGS. 4-9 depict a user interface at a target computing device after synchronization.

FIG. 4 illustrates an exemplary user interface diagram for viewing and managing file system items and related postings according to one embodiment. A user interface window 400 can correspond to a folder in a file system. In one example, the folder can have an associated discussion and users can add postings to the discussion. In another example, a file within the folder can have an associated discussion and users can add postings to the discussion. A posting can be implemented to include a subject, a body, and a user identifier that identifies the user that created the posting. Various arrangements for a discussion can be implemented. In one embodiment, within a discussion, there can be topics and responses. A topic can be top-level posting. A discussion may have any number of topics. A response is a posting that responds to a topic. A topic may have any number of responses. Responses may be presented in a tree view under a topic. Other arrangements of postings are contemplated.

In one embodiment, the user interface provides a discussion window 402. The discussion window 402 can be opened via various user interface mechanisms. For example, a user may double-click on an item within window 400 to display discussion window 402. In another example, users may right-click on a folder and select an option to display discussion window 402. The discussion window can be a multi-instance window associated with a folder, and allows the user to interact with all of the topics and responses.

In one implementation, the display discussion window 402 can have two panes. One pane can be a view pane 404. The view pane 404 can be configured to show the hierarchy of postings. The user may select any posting in the hierarchy. The view pane 404 can display a column for the data, a column for the subject, a column for the author, and any other columns showing information pertaining to the listed posting. The date field is the date and time on which the posting was posted. The subject is the subject line entered by the author of the posting. The author column shows the name or identifier of the author of the posting.

In one implementation, the view pane 404 can show collapse and expand icons next to postings that have children. The user may collapse or expand any part of the hierarchy. The postings in the view pane 404 can be sorted by hierarchy. Within each level, the postings can be sorted by date.

The display discussion window 402 can also include a preview pane 406. The preview page 406 can be configured to show the contents of a selected posting. The preview pane can show the subject line, metadata of the posting such as author, date, time, and the like. In addition, the preview pane 406 can also show the body of the posting.

In one embodiment, a user may create a new posting by selecting a posting button 408. Furthermore, the user may create a response to a selected posting by selecting a reply button 410. The user may open up a posting that the user has created for editing. An edit button 412 can be provided for editing a posting. As such for the owner of the posting, the edit button 412 can be active, while the edit button 412 can be grayed out for all other members. The user may delete a posting that the user has created. A delete button 414 can be provided for deleting a posting. As such for the owner of the posting, delete button 414 can be active, while the delete button 414 can be grayed out for all other members. Other user interface mechanisms can be provided to a user to manipulate postings.

FIG. 5A illustrates an exemplary user interface diagram for viewing and managing file system items and related postings according to another embodiment. In one embodiment, a discussion pane 500 can be provided. The discussion pane 500 can be opened via various user interface mechanisms. For example, a user may hover over or select a file system item and a discussion pane 500 can be displayed listing the postings associated with the file system item selected.

The discussion pane 500 can be configured to shows a flat list of postings. Postings can be ordered by reverse chronological order. Each posting entry can show two lines for each posting. The top line shows the subject of the posting, and the second line can show the time and date on which the posting was originally created and the original author. Furthermore, for postings that are unread, the icon shows an unread indicator (similar to the indicator used for unread files). The discussion pane 500.

An add button 502 can be included as part of the discussion pane 500. In one embodiment, the add button 502 can open up a new top-level window to permit a user to compose a posting associated with the folder or file to which the discussion pane 500 is relevant to. As previously mentioned, a user can add a posting in association with a file system item, and according to the methods and systems described herein, the posting can be synchronized in the computing devices of all other users that choose to be in synchronization with the folder system items, and the postings, of the user.

A view all button 504 can be configured to permit a user to open a discussion window, such as discussion window 402 as discussed in reference to FIG. 4. An options button can also be implemented to show additional options provided to the user.

FIG. 5B illustrates an exemplary user interface diagram for viewing and managing file system items and related postings according to yet another embodiment. The discussion pane 500 can be configured to display the topic and responses associated with that topic. Thus, posting 506 can be the topic of a conversation, and posting 510 is a response. A user can be provided with the ability to expand and collapse the conversation.

In another embodiment, the discussion pane 500 can further include file links associated with each posting. The file links can be included with each posting according to different criteria. In one example, the file links corresponds to the file that the user originally created the posting for. In another example, the file links corresponds to a file that the user included as part of the posting. Thus, for instance, file links 512 can be included as part of the discussion pane 500. The file links can be implemented such that a single-click can be utilized to access the files associated with the file links 512.

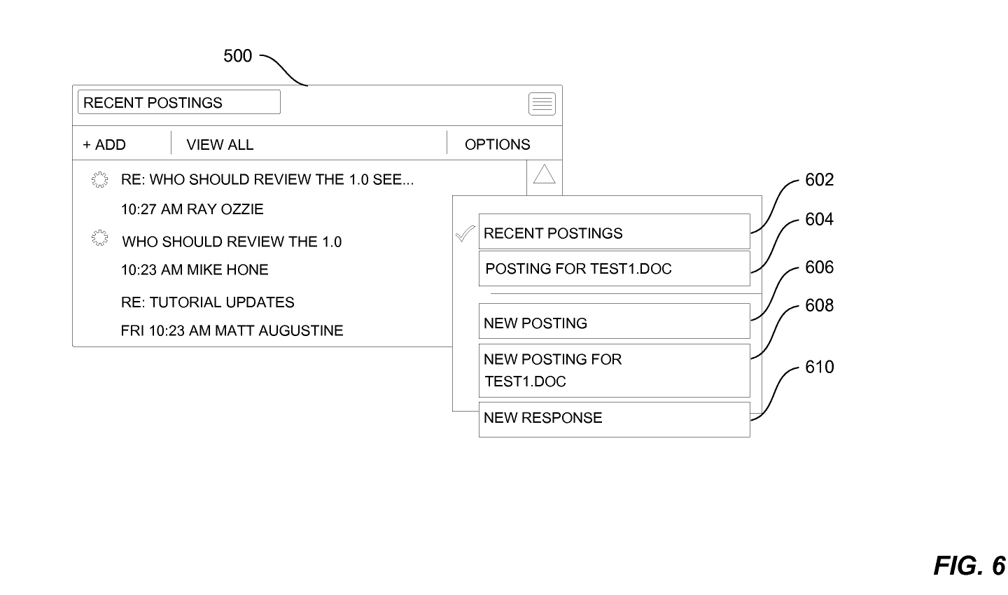

FIG. 6 illustrates an exemplary user interface diagram for viewing and managing postings according to one embodiment. The discussion pane 500 can include a drop-down menu with various options. Exemplary additional options can be accessed via one or more options in the drop-down menu. The menu can include a recent postings button 602, a document postings button 604, a new posting button 606, a new document posting button 608, and a new response button 610.

The recent postings button 602 can be selected if the discussion pane 500 is showing all recent posts, and the user wants to see only the recent postings. The document postings button 604 can be selected if the discussion pane 500 is showing postings for a specific document or file. If no file is selected, this option can be grayed out.

The new posting button 606 can allow a user to create a new topic, while the new document posting button 608 can be enabled when a file is selected, such that a new topic posting can be created with a link to the selected file. The new response button 610 can be enabled when a discussion entry is selected. If selected, the new response button 610 would create a response posting in association with the new response button 610.

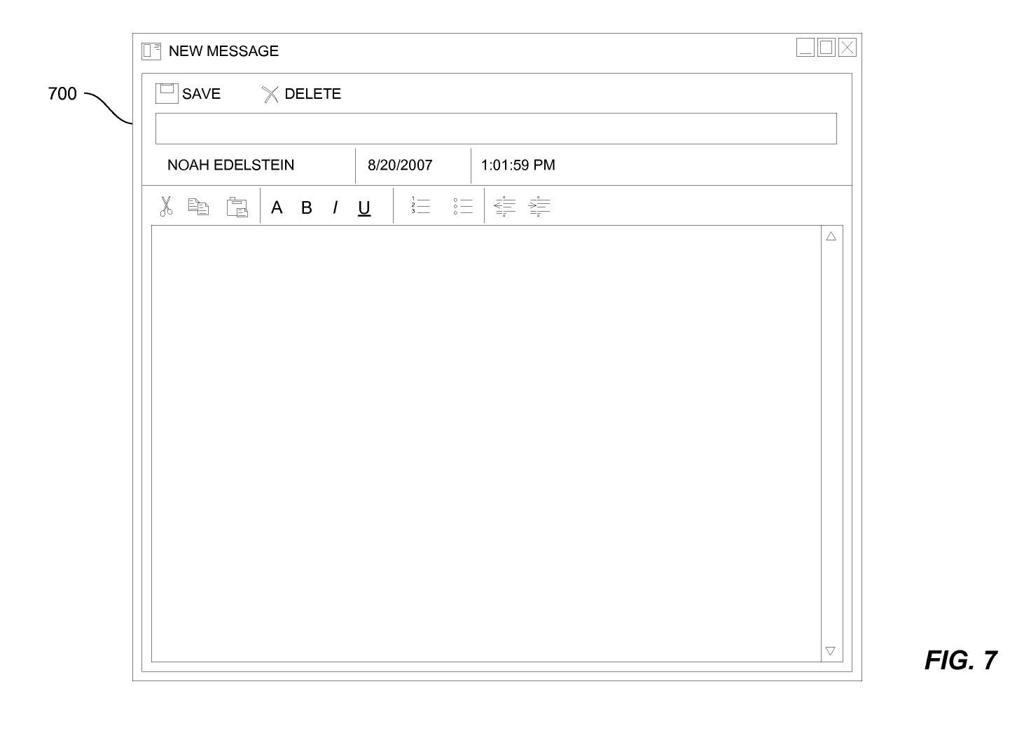

FIG. 7 illustrates an exemplary user interface diagram for entering a posting according to one embodiment. A posting editing window 700 is a top-level window that lets the user create postings. The posting editing window 700 can be configured to allow users to add or edit a posting. Conventional text-editing user interface mechanisms can be provided to allow the user to add or edit the posting. Once created, the user can save the posting. As mentioned previously, once a user adds a posting in association with a file system item, the posting can then be propagated to synchronized computing devices.

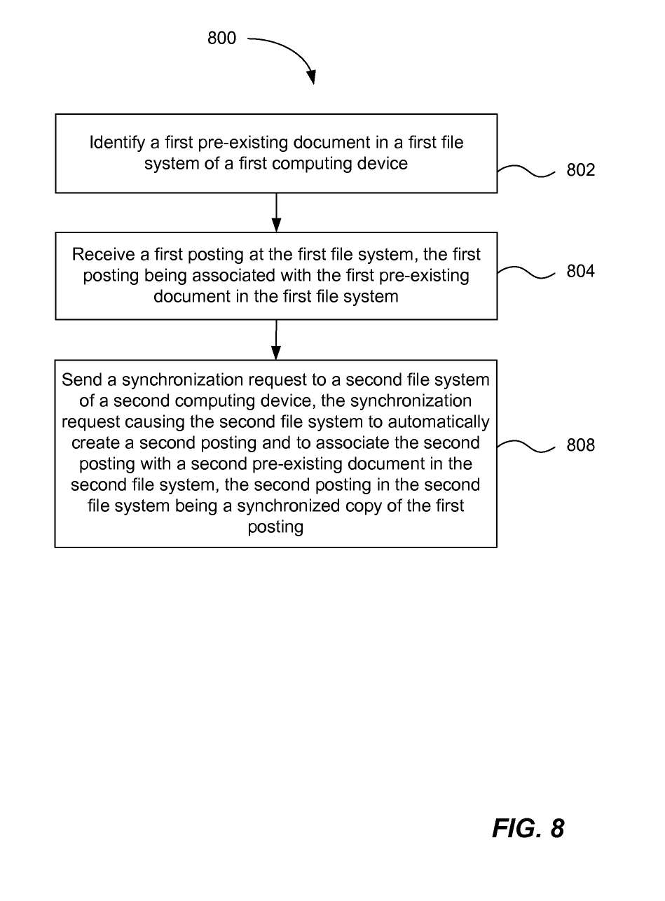

FIG. 8 illustrates a flow diagram of a process for sending a synchronization request to synchronize a posting according to one embodiment. At process block 802, a first pre-existing document is identified in a first file system of a first computing device. Process 800 continues at process block 804. At process block 804, a first posting is received at the first file system. The first posting can be associated with the first pre-existing document in the first file system. Process 800 continues at process block 806.

At process block 806, a synchronization request is sent to a second file system of a second computing device. The synchronization request can cause the second file system to automatically create a second posting and to associate the second posting with a second pre-existing document in the second file system. The second posting in the second file system being a synchronized copy of the first posting.

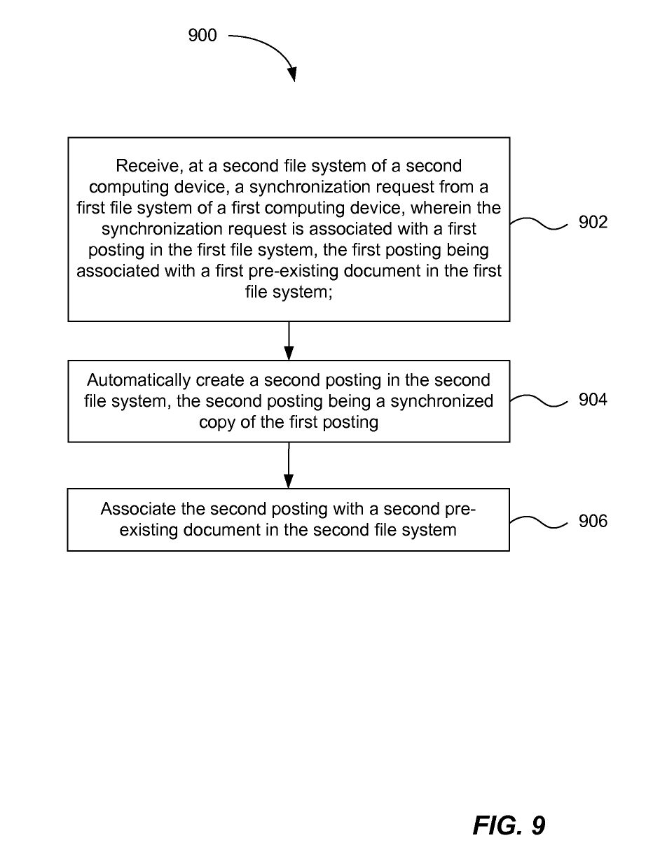

FIG. 9 illustrates a flow diagram of a process for receiving a synchronization request to synchronize a posting according to one embodiment. At process block 902, a synchronization request is received from a first file system of the first computing device. The synchronization request can be received at a second file system of the second computing device, and can be associated with a first posting in the first file system. The first posting can, in turn, be associated with a first pre-existing document in the first file system. Process 900 continues at process block 904.

At process block 904, a second posting is automatically created in the second file system. The second posting can be a synchronized copy of the first posting. Process 900 continues at process block 906. At process block 906, the second posting can be associated with a second pre-existing document in the second file system.

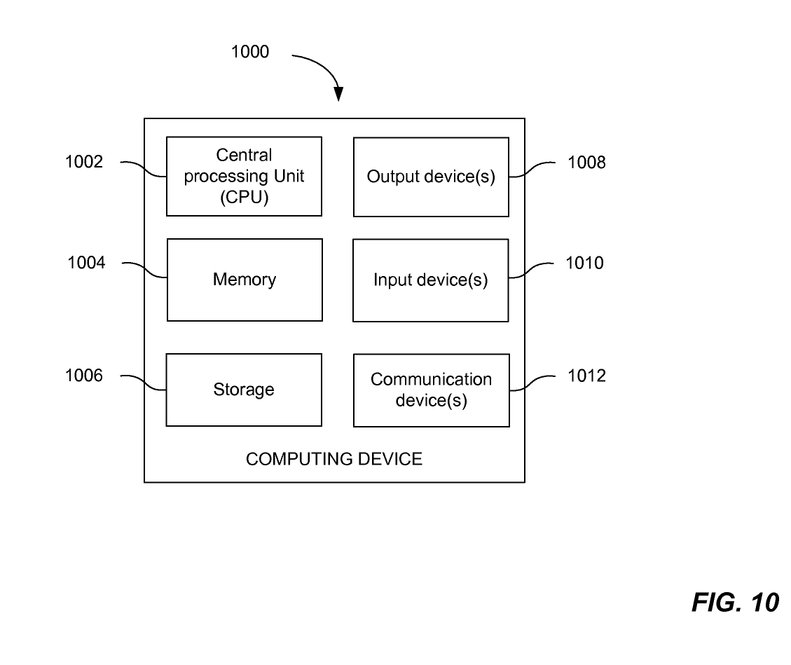

FIG. 10 illustrates a component diagram of a computing device according to one embodiment. The computing device 1000 can be utilized to implement one or more computing devices, computer processes, or software modules described herein. In one example, the computing device 1000 can be utilized to process calculations, execute instructions, receive and transmit digital signals. In another example, the computing device 1000 can be utilized to process calculations, execute instructions, receive and transmit digital signals, receive and transmit search queries, and hypertext, compile computer code, as required by the synchronization module 202, the posting management module 204, and the file system module 206.

The computing device 1000 can be any general or special purpose computer now known or to become known capable of performing the steps and/or performing the functions described herein, either in software, hardware, firmware, or a combination thereof.

In its most basic configuration, computing device 1000 typically includes at least one central processing unit (CPU) 1002 and memory 1004. Depending on the exact configuration and type of computing device, memory 1004 may be volatile (such as RAM), non-volatile (such as ROM, flash memory, etc.) or some combination of the two. Additionally, computing device 1000 may also have additional features/functionality. For example, computing device 1000 may include multiple CPU's. The described methods may be executed in any manner by any processing unit in computing device 1000. For example, the described process may be executed by both multiple CPU's in parallel.

Computing device 1000 may also include additional storage (removable and/or non-removable) including, but not limited to, magnetic or optical disks or tape. Such additional storage is illustrated in FIG. 10 by storage 206. Computer storage media includes volatile and nonvolatile, removable and non-removable media implemented in any method or technology for storage of information such as computer readable instructions, data structures, program modules or other data. Memory 1004 and storage 1006 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 1000. Any such computer storage media may be part of computing device 1000.

Computing device 1000 may also contain communications device(s) 1012 that allow the device to communicate with other devices. Communications device(s) 1012 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 1000 may also have input device(s) 1010 such as keyboard, mouse, pen, voice input device, touch input device, etc. Output device(s) 1008 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A method of synchronizing postings for a file system, comprising:
identifying a first pre-existing document in a first file system of a first computing device;
receiving a first posting at the first file system, the first posting being associated with the first pre-existing document in the first file system; and
sending a synchronization request to a second file system of a second computing device, wherein the synchronization request causes the second file system to automatically create a second posting and to associate the second posting with a second pre-existing document in the second file system, the second posting in the second file system being a synchronized copy of the first posting.

2. The method of claim 1, wherein the second pre-existing document is a synchronized copy of the first pre-existing document.

3. The method of claim 1, wherein the first computing device and the second computing device are peer computing devices that transmit and receive data through a data network.

4. The method of claim 1, further comprising permitting a user to enter the first posting at the first file system via a discussion pane or discussion window.

5. The method of claim 1, wherein the first posting is associated with the first pre-existing document by adding metadata to the first posting that includes a document identifier corresponding to the first pre-existing document.

6. The method of claim 1, wherein the first posting is associated with the first pre-existing document by adding metadata to first pre-existing document that includes a posting identifier corresponding to the first posting.

7. The method of claim 1, wherein associating the first posting with the first pre-existing document in the first file system is performed in response to a user input requesting to make such association.

8. The method of claim 1, wherein associating the first posting with the first pre-existing document in the first file system is performed as a result of the first pre-existing document being opened.

9. The method of claim 1, wherein associating the first posting with the first pre-existing document in the first file system is performed as a result of the first pre-existing document being last edited.

10. A computer-readable medium having computer-executable instructions for causing a computer to perform the steps received in claim 1.

11. A method of synchronizing a posting from a first computing device to a second computing device, comprising:
receiving, at a second file system of the second computing device, a synchronization request from a first file system of the first computing device, wherein the synchronization request is associated with a first posting in the first file system, the first posting being associated with a first pre-existing document in the first file system;
automatically creating a second posting in the second file system, the second posting being a synchronized copy of the first posting; and
associating the second posting with a second pre-existing document in the second file system.

12. The method of claim 11, wherein the second pre-existing document is a synchronized copy of the first pre-existing document.

13. The method of claim 11, wherein the first computing device and the second computing device are peer computing devices that transmit and receive data through a data network.

14. The method of claim 11, wherein the first posting is associated with the first pre-existing document by adding metadata to the first posting that includes a document identifier corresponding to the first pre-existing document.

15. The method of claim 11, wherein the first posting is associated with the first pre-existing document by adding metadata to first pre-existing document that includes a posting identifier corresponding to the first posting.

16. A computer-readable medium having computer-executable instructions for causing a computer to perform the steps received in claim 11.

17. A system of synchronizing computer, comprising:
a file system module that manages a first pre-existing document in a first computing device;
a posting management module that receives a first posting at the first file system, the first posting being associated with the first pre-existing document in the first file system; and
a synchronization module that sends a synchronization request to a second file system of a second computing device, wherein the synchronization request causes the second file system to automatically create a second posting and to associate the second posting with a second pre-existing document in the second file system, the second posting in the second file system being a synchronized copy of the first posting.

18. The system of claim 17, wherein the synchronization module is further configured to receive a synchronization request from the second file system, wherein the synchronization request is associated with a third posting that is associated with the second pre-existing document in the second file system, the synchronization module further configured to automatically create a fourth posting in the first file system, the fourth posting being a synchronized copy of the third posting, the fourth posting being associated the first pre-existing document in the first file system.

19. The system of claim 17, wherein the second pre-existing document is a synchronized copy of the first pre-existing document.

20. The system of claim 17, wherein the first computing device and the second computing device are peer computing devices that transmit and receive data through a data network.

21. A method of synchronizing postings for a file system, comprising:
identifying a first pre-existing folder in a first file system of a first computing device;
receiving a first posting at the first file system, the first posting being associated with the first pre-existing folder in the first file system; and
sending a synchronization request to a second file system of a second computing device, wherein the synchronization request causes the second file system to automatically create a second posting and to associate the second posting with a second pre-existing folder in the second file system, the second posting in the second file system being a synchronized copy of the first posting.

22. The method of claim 21, wherein the second pre-existing folder is a synchronized copy of the first pre-existing folder.

23. A method of synchronizing postings for a file system, comprising:
identifying a first pre-existing file system item in a first file system of a first computing device;
receiving a first posting at the first file system, the first posting being associated with the first pre-existing file system item in the first file system; and
sending a synchronization request to a second file system of a second computing device, wherein the synchronization request causes the second file system to automatically create a second posting and to associate the second posting with a second pre-existing file system item in the second file system, the second posting in the second file system being a synchronized copy of the first posting.

24. The method of claim 23, wherein the file system item is a folder or a file.

25. The method of claim 23, wherein the file system item is a text file, an image file, a media file, a database file, or a configuration file.
